(19) United States
(12) Patent Application Publication
(10) Pub. No.: US 2026/0329780 A1
(43) Pub. Date: Oct. 22, 2026

(54) METHOD FOR CHECKING DATA IN A COMPUTING UNIT

(71) Applicant: Robert Bosch GmbH, Stuttgart (DE)

(72) Inventors: Aparna Vijaya Krishnan, Tamm (DE); Daniel Hoettges, Sprockhoevel (DE); Frederic Stumpf, Leonberg (DE); Hakan Aktas, Asperg (DE); Jens Schmuelling, Ludwigsburg (DE); Martin Assel, Markgroeningen (DE); Peter Poinstingl, Purgstall/Erlauf (AT)

(21) Appl. No.: 19/107,627

(22) PCT Filed: Sep. 5, 2023
(86) PCT No.: PCT/EP2023/074234

§ 371 Date: Feb. 28, 2025

(30) Foreign Application Priority Data
Sep. 14, 2022 (DE) 10 2022 209 628.2

(51) Int. Cl. G06F 12/14

(52) U.S. Cl. CPC G06F 12/1433; G06F 12/1483

(57) ABSTRACT

A method for checking data in a computing unit. The computing unit has a memory unit, a security unit and a memory protection unit. The method includes: storing data to be checked in a specified memory area in the memory unit; configuring, by the security unit, the memory protection unit in order to protect the specified memory area according to a specified access restriction; performing, by the memory protection unit, a memory protection of the specified memory area according to the specified access restriction; checking, by the security unit, the data stored in the specified memory area.

### FIELD

The present invention relates to a method for checking data in a computing unit, and to a computing unit, and a computer program for performing the method.

### BACKGROUND INFORMATION

When checking and subsequently using data in computing units, the so-called TOCTOU problem (time-of-check-to-time-of-use problem) can occur, according to which data at the time of their checking (time of check) can differ from the data at the time of their use (time of use). For example, a security unit, which is provided for checking data, can read data from a memory unit and verify them by means of cryptographic methods. However, if an attacker, e.g., malicious software, that has corrupted the computing unit makes unauthorized changes to the data in the memory unit during or after the data have been checked, these changes can usually no longer be recognized by the security unit. In this case, the security unit may wrongly verify the authenticity and integrity of the data, even though these data were subsequently compromised by the attacker. This can lead to the manipulated data being further processed in the computing unit. Such a security unit usually has no way of recognizing whether the validated data are processed correctly and have not been manipulated in an unauthorized manner after the check.

### SUMMARY

According to the present invention, a method for checking data in a computing unit along with a computing unit and a computer program for performing the method with the features of the present invention are provided. Advantageous embodiments of the present invention are disclosed herein.

The computing unit has a memory unit, e.g., a RAM memory, ROM memory or flash memory, a security unit or a security module and a memory protection unit. The security unit is provided in particular as a secure or protected unit for executing cryptographic operations. The memory protection unit (MPU) is in particular provided in order to receive and manage access requests to a memory unit. It is understood that the computing unit can comprise further hardware units and software units, such as a processor unit, input interfaces, output interfaces, etc.

Within the framework of the method according to an example embodiment of the present invention, data to be checked are stored in a specified memory area or in a specified address area in the memory unit. For example, these data can be stored in the specified memory area by a processor unit or by processes or applications executed by the processor unit.

The security unit configures the memory protection unit or instructs the memory protection unit in order to protect the specified memory area according to a specified access restriction. Due to this access restriction, it can be specified in particular which units of the computing unit are allowed to access the specified memory area and the data stored there and which units are prohibited from accessing them. In particular, the memory protection unit itself specifies this access restriction.

Following this configuration, the memory protection unit performs a memory protection of the specified memory area according to the specified access restriction or the memory protection unit sets up the memory protection accordingly. When the memory protection unit subsequently receives an access request to this memory area, the memory protection unit can, in the course of this memory protection, expediently allow or block the corresponding requested access according to the specified access restriction.

The data stored in the specified memory area are checked by the security unit, in particular with the aid of cryptographic operations, e.g., with the aid of keys and/or further cryptographic methods, which can be stored in a special memory unit of the security unit. For example, the security unit can calculate a cryptographic signature for this purpose. Due to this check, the data can be checked, in particular, for authenticity, correctness or integrity. However, the specific type of check is not important.

A result of this check can be stored by the security unit in the computing unit, in particular in the memory unit itself in a further specified memory area. If the stored data have been validated in the course of the check or if their authenticity has been verified, the data can in particular be used or released for further processing in the computing unit. On the other hand, if authenticity cannot be verified, the data may, for example, be discarded and not released for further processing.

Due to the present invention, the so-called TOCTOU problem (time-of-check-to-time-of-use problem) is addressed in a particularly expedient manner. The present invention provides a cost-effective, efficient and secure way to prevent unrecognized, unauthorized manipulation of data during or after their check. Due to the definition and implementation of access restrictions, only trusted, secure units can be permitted to access the data. In this way, it can be expediently prevented that the data are manipulated while or after the data are being checked or have been checked by the security unit. Due to the specified access restriction and the memory protection performed, the memory area where the data to be checked are stored can be protected from unauthorized access, for example at least until the data have been further processed after their verification. If an attacker attempts to access and change the data that are to be checked or have already been checked by the security unit, this attempted access is expediently blocked by the memory protection unit through the memory protection that has been set up. In this way, it can be prevented that a potential attacker who has taken over the computing unit or the software system, excluding the security unit, passes manipulated information to the security unit and/or makes unauthorized changes to the contents in the memory area during the check by the security unit. In particular, the security unit can dynamically configure the memory protection unit in order to individually protect individual memory areas or address areas in the memory unit. Due to this interaction between the security unit and the memory protection unit, a dynamic memory protection unit can in particular be provided, which can be dynamically configured online and on demand by the security unit during operation of the computing unit.

In particular, the method according to the present invention provides a cost-effective way to dynamically protect individual memory areas before the data check. The rest of the memory areas of the memory unit can continue to be used regularly during operation of the computing unit. For example, costs and resources can be saved in this way in comparison to a dedicated memory unit or a dedicated memory area, which is exclusively assigned to the security unit and which only the security unit is allowed to access during the runtime of the computing unit. Furthermore, the method allows a trust boundary and/or a security zone of the security unit to be efficiently and dynamically increased by further memory areas.

Furthermore, for checking the data, the method makes it possible for the security unit to directly access the memory unit, which is also used during regular operation of the computing unit, as a result of which, for example, the check of large data volumes is made possible in a simple manner. In the conventional way, it is often not readily possible to copy large memory areas or large data volumes to a security unit, e.g., for checking longer certificate chains or in the context of software updates. Since longer certificate chains take up a larger memory area, they are usually not stored in a secure memory area. For transferring such certificate chains, parsing or splitting is often performed, which may require the execution of untrusted applications. In contrast, within the framework of the present method, even large memory areas can be transferred to the security unit completely, securely and in a tamper-proof manner. This also makes it possible, for example, to securely check long cryptographic certificate chains, e.g., X.509 certificates.

Furthermore, the method of the present invention can make a secure flash or secure flashing of data in a memory possible by programming data or software into the memory unit by a host, e.g., by a processor unit of the computing unit or by applications executed in the computing unit, and by performing a signature check of this programmed software by the security unit. Since the integrity of the software can be maintained by the present method, the method can in particular prevent a manipulated host can from manipulating the programmed software after its validation but before its execution.

For example, the present method is suitable for computing units in which secure booting is not possible, and also for systems in which larger data volumes are to be verified. Even if the computing unit uses and implements a secure boot method, the data check according to the present method can, for example, limit and reduce the effects of runtime attacks.

The security unit can, for example, be a hardware-based unit, or a unit implemented in hardware, e.g., a so-called hardware security module (HSM), in particular an internal or external peripheral device for executing cryptographic operations. Furthermore, the security unit can, for example, also be implemented in software or be software-based, e.g., as a secure or trusted runtime environment (trusted execution environment, TEE), which represents a secure area of a processor unit in which only specifically approved applications are allowed to be executed. For example, such a TEE environment can be designed as a so-called trust zone, wherein virtual processors are provided as a secure runtime environment.

According to an example embodiment of the present invention, for managing access to the memory unit by the memory protection unit, a table can be used, for example, to store which address areas or memory areas of the memory unit are allowed to be accessed by which units of the computing unit, in particular by which processor units and/or by which processes or applications.

If the memory protection unit receives an access request to a specific memory area, the memory protection unit uses this table to check whether or not the requesting unit is allowed to access this memory area. Accordingly, the memory protection unit allows or blocks the requested access. For example, for configuring the memory protection unit, the security unit can create or change entries in this table with respect to the corresponding memory area. The memory protection unit then implements these entries and only allows the permitted accesses, as a result of which the corresponding memory protection is performed or set up by the memory protection unit.

Advantageously, the computing unit of the present invention is configured such that only the security unit can or is allowed to configure the memory protection unit. In particular, this means that only the security unit is allowed to define which memory areas are to be dynamically protected. Further hardware units and software units of the computing unit, which can be considered untrusted and potentially corrupted for security reasons, are therefore expediently not allowed to configure the memory protection unit in order to define, change or remove a memory protection. In this way, it can be prevented in particular that an attacker who has, for example, taken over the computing unit, excluding the security unit, changes the memory protection and manipulates the data without being noticed.

Particularly advantageously, according to an example embodiment of the present invention, the specified access restriction means that only the security unit can or is allowed to access the specified memory area for reading and writing. Further units in the computing unit, e.g., processes, applications, processor units, processor cores, etc., are allowed in particular to access the specified memory area only for reading or not at all. Changes to the memory area can thus be made exclusively and only by the security unit; at least write access is prohibited for the rest of the hardware units and software units of the computing unit. This makes it particularly expedient to prevent unauthorized changes to the data during or after the check by the security unit.

Particularly expediently, according to an example embodiment of the present invention, the computing unit is configured such that the security unit can individually define in the access restriction for individual units of the computing unit, e.g., for individual processor cores, whether the respective unit is granted read and write access or only read access or no access to the specified memory area. For example, a specific processor core that is scheduled to process the data can be granted read access to the memory area, whereas the rest of the processor cores is not granted access. For example, according to the access restriction, read and write access to the memory area can be prohibited if specific data to be protected are only to be readable after the security unit checks and releases them, e.g., algorithms that need to be protected.

Preferably, according to an example embodiment of the present invention, upon receipt of an access request to the specified memory area for access, in particular for writing, which is not permitted according to the specified access restriction or which violates the specified access restriction, it is decided or assessed or evaluated whether the security unit initiates a removal or change of the memory protection of the specified memory area and/or whether the access according to the access request is redirected to another memory area, e.g., to another memory area in the memory unit or in a further memory unit of the computing unit. For example, upon receipt of such an access request, a notification, in particular an interrupt message, further in particular an exception message, can be sent, for example to the security unit and/or to a processor unit of the computing unit. The decision on how to deal with the access request can then be made by the security unit or the processor unit upon receipt of this notification, in particular by a special unit for processing such notifications (exception handler).

Preferably, according to an example embodiment of the present invention, after the stored data have been checked by the security unit, in particular if the stored data have been validated in the course of the check or if their authenticity has been verified, the security unit reconfigures the memory protection unit in order to remove the memory protection of the specified memory area. For example, for this purpose, the security unit can change or delete the corresponding entries in the corresponding table of the memory protection unit that define permitted or prohibited accesses to the memory area by various units of the computing unit. Following this configuration, the memory protection of the specified memory area is removed or no longer performed by the memory protection unit. For example, the memory protection can be removed after the data have been successfully validated, so that further units can access the data and process them further. In particular, this removal of the memory protection can take place promptly or immediately before a planned, authorized access to the data, in order to minimize the possibility of unauthorized manipulation of the data.

Alternatively, according to an example embodiment of the present invention, after the security unit has checked the stored data, in particular if the stored data have been validated in the course of the check or if their authenticity has been verified, the security unit preferably reconfigures the memory protection unit, in order to protect the specified memory area according to a second specified access restriction. This second memory protection of the specified memory area is then performed by the memory protection unit according to the specified second access restriction. For example, according to this second access restriction, certain units that are scheduled to access the validated data can be granted corresponding read and/or write access.

Preferably, according to an example embodiment of the present invention, the memory protection unit is reconfigured to remove the memory protection or to perform the second memory protection after a start cycle. During such a start cycle, in particular initially when booting the computing unit or the system, the memory protection is expediently still active. The corresponding data can thus still be protected even after a reset, for example. For example, after the start cycle, the security unit first gives approval to the host to remove the memory protection. For example, this can be achieved by a memory protection unit reset value or by a non-volatile memory protection unit configuration that is set by the system after the reset, either by the security unit if it is started before the host or by hardware features in the controller during reset. In this way, it can be ensured in particular that the data cannot be manipulated by a restart.

Advantageously, according to an example embodiment of the present invention, after checking the stored data, the security unit stores a result of the check in a further memory area of the memory unit or in a further memory unit of the computing unit. Furthermore, the security unit removes or changes the memory protection so that a processing unit is allowed to access the memory area at least for reading, wherein this processing unit can be a host, for example a process, an application, a processor unit, a processor core, etc. If the stored data have been validated according to the stored result or if their authenticity has been confirmed, the processing unit reads the stored and checked data and processes them.

Advantageously, after the data to be checked have been stored in the specified memory area, the security unit is instructed to check the data stored in the specified memory area. For example, this instruction can be given by the processing unit which is to access the data and process them further. For example, the processing unit can issue or transmit a corresponding instruction, message or request to the security unit for this purpose. The security unit thus expediently configures the memory protection unit in response to a corresponding request from a software application of the computing unit.

Preferably, according to an example embodiment of the present invention, for such an instruction of the security unit, a corresponding instruction is stored in a further memory area of the memory unit or in a further memory unit of the computing unit. In particular, this instruction can contain the specific memory address where the data to be checked are stored. A notification, in particular an interrupt, is sent to the security unit. In particular, this notification can contain the memory address where the instruction is stored. Following receipt of this notification, the security unit reads the stored instruction and checks the data.

According to an advantageous embodiment of the present invention, the data to be checked are part of an update and can, for example, comprise new firmware for the computing unit or a new part of firmware or new data for firmware. For example, the update can be an OTA (over-the-air) update, in particular a so-called FOTA (flashing-over-the-air) or SOTA (software-over-the-air) update, in the course of which the update data are transferred via a radio connection, e.g., via the Internet. Before the data or update data are stored in the specified memory area, the data are first received via an interface of the computing unit, e.g., via a radio interface and/or diagnostic interface. After receiving the data, the memory area is protected by the security unit and the memory protection unit with the aid of the access restriction and the memory protection. Subsequently, the security unit checks the data, in particular in order to determine whether the data have been received completely and correctly and whether no malicious software has been transferred. After the stored data have been checked and validated, the data are activated in the specified memory area or installed in another memory area, e.g., in a further memory area of the memory unit or in a further memory unit of the computing unit. After such activation or installation, the update data can be used in future program runs.

Due to the method of the present invention, it can be ensured that the update data cannot be manipulated in an unauthorized manner between their check and their activation or installation. This is a particularly expedient way to address the TOCTOU problem with OTA updates.

In order to download and check update data in the traditional way, it is possible to use, for example, an explicitly reserved memory that can only be changed by a hardware security module (HSM), which then checks the data. However, such explicit memory can be associated with high costs, especially since this memory remains unused in the case of the normal application.

Alternatively, a cache outside the HSM is also often used, which can then usually be accessed and consequently manipulated by (insecure) host CPUs. For example, when installing the update data or firmware in the HSM, it can be checked again whether any manipulation has taken place. However, this can lead to an availability problem, since the old data or the old firmware may already have been at least partially overwritten and may no longer be available for a rollback.

In contrast, the method of the present invention makes it possible to use any memory within the system for updates, so that no explicitly reserved memory is necessary and the system is available at all times. Since the transfer of data can be disturbed or interrupted, e.g., by an attack or radio interference, a memory area that can completely accommodate the new memory content can be specified for storing the update data, in particular for denial-of-service and availability reasons. This ensures that the system remains fully functional during the download. In parallel, this reserved, specified memory area is filled with the loaded data. The specified memory area can in particular be any memory area in the system. After completion of the transfer to the memory area, the system expediently triggers the security unit. Then, the security unit particularly expediently defines for itself exclusive access to the memory area according to the specified access restriction, so that at least write access is prohibited for other units. Thereafter, the security unit starts checking the new memory content. If the memory area is used as a temporary cache, wherein the update data are copied to another destination after they have been checked, the exclusive access can be removed again after the check and the cache can be released again for other units.

The method of the present invention is particularly suitable for use in the (motor) vehicle sector. The computing unit can, for example, be a microcontroller or a control unit of a (motor) vehicle, e.g., an engine, domain, airbag, brake control unit, etc. The data to be checked can, for example, be vehicle data that are recorded, for example, by sensors of the vehicle. For example, these data can be processed in the course of safety-critical functions, which are performed for the safe operation and control of the vehicle, for example in the course of engine, domain, airbag and/or brake control, in the course of driver assistance functions, in the course of assisted autonomous driving (IAD) or, in general, automated or partially automated driving, etc. Furthermore, the data to be checked can also be an update of control unit software or vehicle software. Due to the present method, in particular, a high level of operational safety or functional safety along with, further in particular, a high level of information technology security or information security possible, can be made possible. In particular, safety or failure safety and integrity of the control unit can be increased. Furthermore, due to the method, safety requirements in the (motor) vehicle sector, such as those specified in the ISO 26262 standard or in particular by the so-called automotive safety integrity level (ASIL), a safety requirement level specified by ISO 26262 for safety-relevant systems in motor vehicles, can be met in a particularly expedient manner.

A computing unit according to the present invention, e. g., a control unit of a (motor) vehicle, is configured, in particular in terms of programming, to perform a method according to the present invention.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.) . Such a download can be wired or wireless (e.g., via a WLAN network or a 3G, 4G, 5G or 6G connection, etc.).

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 schematically shows an example embodiment of a computing unit according to the present invention, which is configured to perform an example embodiment of a method according to the present invention.

FIG. 2 schematically shows an example embodiment of a method according to the present invention as a block diagram.

### DETAILED DESCRIPTION OF EXAMPLE EMBODIMENTS

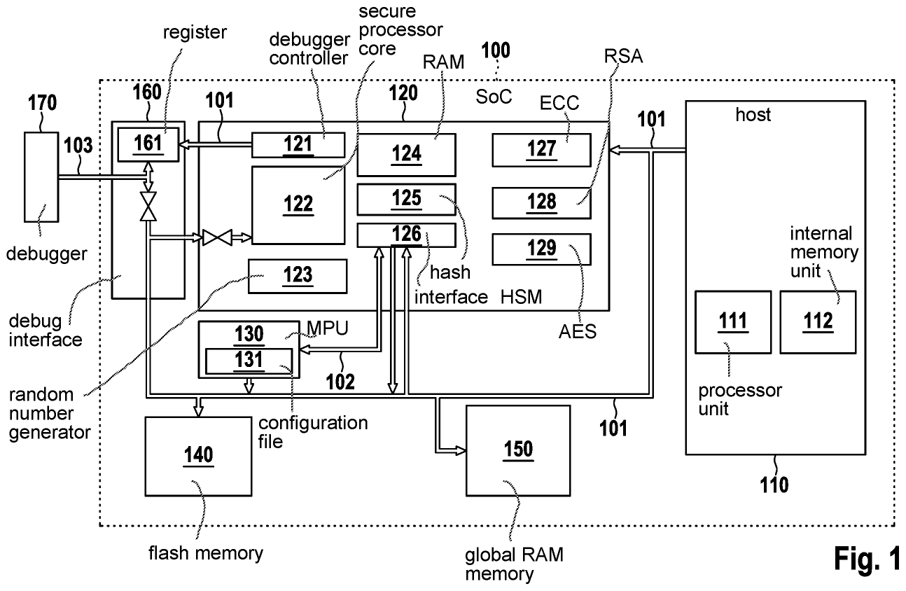

FIG. 1 schematically shows a computing unit in the form of a system on a chip (SoC), which is designated by 100 and used, for example, in a microcontroller of a control unit in a (motor) vehicle.

The SoC 100 has a host 110, which in turn has a processor unit 111, e.g., a multi-core processor with a plurality of processor cores, and a local, internal memory unit 112, e.g., a RAM memory. The SoC 100 furthermore has global, shareable memory units, e.g., a flash memory 140 and a global RAM memory 150. The host 110 and the memory units 140 150 along with further components of the SoC 100 are in communication with one another via an on-chip interconnect (OCI) 101.

Furthermore, the SoC 100 has a security unit 120, e.g., a hardware security module (HSM), which is provided in order to check data stored in the memory units 140, 150 for authenticity, correctness or integrity, for example by means of cryptographic methods. The HSM 120 has, for example, a debugger controller 121 and a secure processor core 122, a random number generator 123 comprising a true random number generator (TRNG) and a pseudo random number generator (PRNG), a secure local RAM memory 124, a unit 125 for hash functions, an interface 126 for the on-chip interconnect, a unit 127 for elliptic curve cryptography (ECC), a unit 128 for encryption and signing according to the cryptographic RSA (Rivest-Shamir-Adleman) method and a unit 129 for an advanced encryption standard (AES).

The HSM 120 is connected to a memory protection unit (MPU) 130 via a secure bus connection 102. The MPU 130 is provided in order to monitor access requests to the memory units 140 and 150 and to permit or block corresponding requested accesses. For this purpose, the MPU 130 can be configured with the aid of a configuration file 131, which comprises a table containing which units of the SoC 100 are allowed to access which memory areas or address areas of the memory units 140, 150 and which units are denied access. In particular, only the HSM 120 may be allowed to change this configuration of the MPU 130.

A debugger 170 for recognizing errors in the SoC 100 can be connected, as an external peripheral device not implemented on the SoC 100, via a connection 103 (e.g., a so-called debug access port, DAP) to a debug interface 160 of the SoC 100, which debug interface can have a register 161, for example.

If the host 110, e.g., the processor unit 111 or applications executed in the processor unit 111, is to access data stored in the memory units 140, 150 and to process these data, it may be important for the HSM 120 to first check the data for correctness and integrity, for example if the data are to be processed in the course of safety-critical functions of the vehicle.

During such a check and subsequent use of data, the so-called TOCTOU problem (time-of-check-to-time-of-use problem) can traditionally occur often, for example if an attacker who has corrupted the SOC 100 makes unauthorized changes to the data during or after the check of the data by the HSM 120, so that the HSM 120 can no longer recognize these changes.

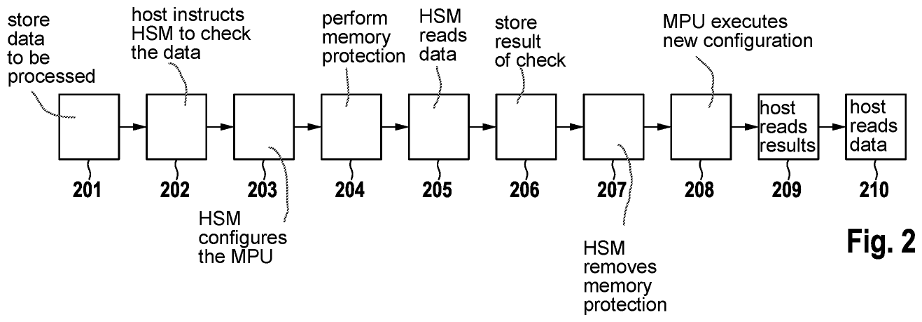

In order to prevent such unrecognized, unauthorized manipulation of data according to the TOCTOU problem, the SoC 100 is configured, in particular in terms of programming, to perform an embodiment of a method according to the present invention, which is shown schematically as a block diagram in FIG. 2 and explained below with reference to FIGS. 1 and 2.

In a step 201, data to be processed are stored in a specified address area or memory area, for example of the flash memory 140. For example, these data can be sensor values of the vehicle, which are to be further processed by the host 110, for carrying out a vehicle function, e.g., engine control.

In a step 202, the host 110 instructs the HSM 130 to check the data stored in the specified memory area. For this purpose, the host 110 stores a corresponding instruction in a further, second memory area of the flash memory 140, which instruction contains, for example, the memory address of the data to be checked. Furthermore, the host 110 sends a notification, in particular an interrupt, to the HSM 120, which then reads the stored instruction.

In a step 203, the HSM 120 configures the MPU 130 in order to protect the specified memory area in the flash memory 140 according to a specified access restriction. For example, according to this access restriction, only the HSM 120 can access the specified memory area for reading and writing. For example, other units of the SoC 100 may not be allowed read or write access. For configuring the MPU 130, the HSM 120 can, for example, create or change an entry in the table of the configuration file 131.

In a step 204, the MPU 130 performs a memory protection of the flash memory 140 according to the specified access restriction. If a unit other than the HSM 120 now wants to access the specified memory area, the MPU 130 blocks this access.

In a step 205, the HSM 120 reads the data stored in the specified memory area and checks the read data. For this purpose, with the aid of cryptographic methods, the HSM 120 checks the correctness and integrity of the read data.

In a step 206, the result of the check is stored in a further, third memory area in the flash memory 140.

In a step 207, the HSM 120 removes the memory protection of the specified memory area or at least changes the memory protection such that the host 110 is allowed to access the specified memory area at least for reading. For this purpose, the HSM 120 reconfigures the MPU 130 and changes the corresponding entry in the table in the configuration file 131, for example, such that the memory protection is removed and all units of the SoC 100 are allowed to access the specified memory area, or, for example, such that a second memory protection is set up, according to which not only the HSM 120 but also the host 110 is allowed to access the specified memory area at least for reading.

In a step 208, the MPU 130 executes the corresponding new configuration. If the memory protection is to be removed according to the new configuration, the MPU 130 will from then on allow all access to the specified memory area. If the second memory protection is to be implemented, the MPU 130 only allows the HSM 110 read and write access and the host read access.

In a step 209, the host 110 reads the result of the check from the third memory area. If the result shows that the data have been validated, the host 110 reads the data in step 210 and processes them.

Due to the definition and implementation of access restrictions and memory protection, it can be prevented that data are manipulated between their check by the HSM 120 and the processing by the host 110. Due to the interaction of HSM 120 and MPU 130 within the framework of the present method, a dynamic memory protection unit is defined, which can dynamically protect the address areas of the memory units 140, 150. This dynamic memory protection unit 130 can be configured on demand by the hardware security module 120 upon request of a software application of the host 110 and can protect the address areas accordingly. After the specified memory area has been protected accordingly by the MPU 130, only the hardware security module 120 can make changes to this memory area.

The data to be checked may also be update data, which have been received via the Internet, for example in the course of OTA updates, and have been stored in the specified memory area. After the stored data have been checked and validated, the data can then be activated in the specified memory area or installed in another memory area, so that the update data can be used in future program runs. Due to the present method, it can thus be ensured that the update data are not manipulated in an unauthorized manner between their check and their activation or installation.

1-13. (canceled)

14. A method for checking data in a computing unit, wherein the computing unit has a memory unit, a security unit, and a memory protection unit, comprising the following steps:
storing data to be checked in a specified memory area in the memory unit;
configuring, by the security unit, the memory protection unit, in order to protect the specified memory area according to a specified access restriction;
performing, by the memory protection unit, a memory protection of the specified memory area according to the specified access restriction; and
checking, by the security unit, the data stored in the specified memory area.

15. The method according to claim 14, wherein the computing unit is configured such that only the security unit can configure the memory protection unit.

16. The method according to claim 14, wherein the specified access restriction includes that only the security unit can access the specified memory area for reading and writing.

17. The method according to claim 14, further comprising:
upon receipt of an access request to the specified memory area for an access which is not permitted according to the specified access restriction:
deciding: (i) whether the security unit initiates a removal or change of the memory protection of the specified memory area and/or (ii) whether the access according to the access request is redirected to another memory area.

18. The method according to claim 14, further comprising:
after the security unit has checked the stored data:
(i) configuring, by the security unit, the memory protection unit, in order to remove the memory protection of the specified memory area, and removing, by the memory protection unit, the memory protection of the specified memory area; or
(ii) configuring, by the security unit, the memory protection unit, in order to protect the specified memory area according to a second specified access restriction, and performing, by the memory protection unit, a second memory protection of the specified memory area according to the specified second access restriction.

19. The method according to claim 18, wherein configuring the memory protection unit for removing the memory protection or for performing the second memory protection, is carried out after a start cycle.

20. The method according to claim 14, further comprising:
after the security unit has checked the stored data:
storing, by the security unit, a result of the check in a further memory area of the memory unit or in a further memory unit of the computing unit,
removing or changing, by the security unit, the memory protection, so that a processing unit is allowed to access the specified memory area at least for reading,
reading, by the processing unit, the stored result of the check, and
processing, by the processing unit, the data.

21. The method according to claim 14, further comprising:
after the data to be checked have been stored in the specified memory area:
instructing the security unit in order to check the data stored in the specified memory area.

22. The method according to claim 21, wherein instructing the security unit includes:
storing a corresponding instruction in a further memory area of the memory unit or in a further memory unit of the computing unit;
sending a notification, including an interrupt, to the security unit;
reading, by the security unit, the stored instruction following the notification.

23. The method according to claim 14, wherein the data to be checked are part of an update, and wherein the method further comprises:
before the data are stored in the specified memory area, receiving the data via an interface of the computing unit;
after the security unit has checked the stored data, activating the data in the specified memory area or installing the data in another memory area.

24. A computing unit configured to check data in a computing unit, the computer unit comprising:
a memory unit;
a security unit; and
a memory protection unit;
wherein the computing unit is configured to:
store data to be checked in a specified memory area in the memory unit,
configure, by the security unit, the memory protection unit, in order to protect the specified memory area according to a specified access restriction,
perform, by the memory protection unit, a memory protection of the specified memory area according to the specified access restriction, and
check, by the security unit, the data stored in the specified memory area.

25. A non-transitory machine-readable storage medium on which is stored a computer program for checking data in a computing unit, wherein the computing unit has a memory unit, a security unit, and a memory protection unit, the computer program, when executed by the computing unit, causing the computing unit to perform the following steps:
storing data to be checked in a specified memory area in the memory unit;
configuring, by the security unit, the memory protection unit, in order to protect the specified memory area according to a specified access restriction;
performing, by the memory protection unit, a memory protection of the specified memory area according to the specified access restriction; and
checking, by the security unit, the data stored in the specified memory area.
